(19) United States
(12) Patent Application Publication
(10) Pub. No.: US 2020/0281114 A1
(43) Pub. Date: Sep. 10, 2020

(54) Robotic Work Tool System and Method for Controlling a Robotic Work Tool System

(71) Applicant: HUSQVARNA AB, Huskvarna (SE)

(72) Inventors: Patrik Jägenstedt, Tenhult (SE); Mikael Alexiusson, Ulricehamn (SE); Stefan Grufman, Bankeryd (SE); Fredrik Kallström, Huskvarna (SE); Mattias Kamfors, Jonkoping (SE)

(21) Appl. No.: 16/809,737

(22) Filed: Apr. 7, 2020

(30) Foreign Application Priority Data
Mar. 5, 2019 (SE) 1950279-8

(51) Int. Cl. A01D 34/00; G05D 1/02

(52) U.S. Cl. CPC A01D 34/008; G05D 1/0223; A01D 2101/00; G05D 2201/0208; G05D 1/0272

(57) ABSTRACT

A robotic work tool system comprising at least one input device, a robotic work tool and at least one controller. The at least one input device is configured to receive trajectory data representing a desired travel route. The trajectory data includes at least one of a distance value, a direction value and a velocity value. The robotic work tool comprises at least one motor configured to drive at least one wheel of the robotic work tool. The at least one controller is configured to receive the trajectory data and to determine a control sequence for the at least one motor. The control sequence is a sequence of different power and/or velocities which the at least one wheel is to be driven with. The at least one controller is further configured to control the at least one motor according to the determined control sequence. The at least one controller is further configured to receive and process travel data relating to the driven travel route.

### TECHNICAL FIELD

The present disclosure relates to a robotic work tool system as well as a method for improved control of a robotic work tool.

### BACKGROUND

A robotic work tool is an autonomous robot apparatus that is used to perform certain tasks, for example for cutting lawn grass. A robotic work tool is generally controlled by defining an area, hereinafter referred to as a work area, in which the robotic work tool is intended to operate. The work area is defined by a perimeter enclosing the work area. The perimeter includes borders, or boundaries, which the robotic work tool is not intended to cross. The robotic work tool is typically configured to work in a random pattern inside the work area.

During the years, when improving the operation and the control of robotic work tools, the focus has mainly been directed towards different ways of defining and setting the boundaries to the work areas. Traditionally, the boundaries for the work area have been set by physical wires. Over the years, the physical boundaries have further been supplemented with non-physical wires by using a satellite navigation device and/or a deduced reckoning navigation sensor. The robotic work tool is then configured to compare successive determined positions of the robotic work tool against a set of geographical coordinates defining the boundary of the work area in order to stay within the work area.

However, even if the ways of defining work areas have generally improved the operation of robotic work tools and have overcome many disadvantages, the inventors have realized that there are limited possibilities to control the robot work tool within the working area. There are also limited possibilities to interact with the robotic work tool. Thus, there is a need for an improved way of controlling, and interacting with, a robotic work tool, such as a robotic lawn mower.

### SUMMARY

The inventors of the various embodiments have realized, after inventive and insightful reasoning, that there are occasions when it is not enough that the boundaries of a work area have been defined with precision. There are occasions when it is desirable to be able to control, or steer, the robotic work tool more exactly also within the work area, e.g. in accordance with a detailed travel route. One example of such occasion could be if a large part of a work area should be left untouched, e.g. in a meadow, but it is desirable to have a path cut across the meadow. Furthermore, it may also be desirable to take advantage of information that the robotic work tool may receive while travelling along the desired travel route. This information may be used to get feedback about the travelled route and for taking subsequent decisions related to the travelled route and/or the robotic work tool. Thus, there is a need for a solution which allows to control, or steer a robotic work tool to travel in accordance with a desired travel route and there is a need for a solution which allows an increased interaction with the robotic work tool.

In view of the above, it is therefore a general object of the aspects and embodiments described throughout this disclosure to provide a solution for controlling, and interacting with, the robotic work tool in an improved way.

This general object has been addressed by the appended independent claims. Advantageous embodiments are defined in the appended dependent claims.

According to a first aspect, there is provided a robotic work tool system for improved control of, and interaction with, a robotic work tool.

In one exemplary embodiment, the robotic work tool system comprises at least one input device. The at least one input device is configured to receive trajectory data representing a desired travel route of a robotic work tool. The trajectory data includes at least one of a distance value, a direction value and a velocity value. The robotic work tool system further comprises a robotic work tool. The robotic work tool comprises at least one motor. The at least one motor is configured to drive at least one wheel of the robotic work tool. The robotic work tool system further comprises at least one controller for controlling operation of the robotic work tool. The at least one controller is configured to receive the trajectory data representing the desired travel route of the robotic work tool from the at least one input device and to determine, based on the trajectory data, a control sequence for the at least one motor. The control sequence is a sequence of different power and/or velocities which the at least one wheel is to be driven with. The at least one controller is further configured to control the at least one motor according to the determined control sequence causing the robotic work tool to be operative to travel in accordance with the received trajectory data representing the desired travel route. The at least one controller is further configured to receive, from the robotic work tool, travel data relating to the driven travel route, wherein the travel data is received while the robotic work tool is caused to travel in accordance with the received trajectory data representing the desired travel route. The at least one controller is further configured to process said travel data relating to the driven travel route.

In one embodiment, the robotic work tool system comprises a user interface configured to receive user input from a user during the user's operation and interaction with the user interface. The user interface is configured to receive input related to the desired travel route. The at least one input device may, for example, comprise the user interface. The user interface may then be configured to receive trajectory data representing the desired travel route of the robotic work tool.

In one embodiment, the at least one input device comprises a recording device, wherein the recording device is configured to record a travel route of the robotic work tool while the robotic work tool is moved along a travel route representing the desired travel route of the robotic work tool. The recording device may, for example, be configured to record the travel route of the robotic work tool while the robotic work tool is pulled backwards or forwards along a travel route representing the desired travel route of the robotic work tool. Alternatively, the recording device may be configured to record the travel route of the robotic work tool while the at least one wheel of the robotic work tool is spun a distance representing the desired travel route of the robotic work tool.

In one embodiment, the recording device is an encoder. The encoder is configured to record the travel route of the robotic work tool by tracking rotation of the at least one wheel.

In one embodiment, the controller is further configured to determine the control sequence for the at least one motor by scaling the received trajectory data representing the desired travel route by a scaling factor. The at least one input device may, for example, be configured to receive input representing the scaling factor.

In one embodiment, the robotic work tool further comprises a collision sensor configured to detect a collision when the robotic work tool is caused to travel in accordance with the received trajectory data representing the desired travel route. Information of a detected collision is communicated to the at least one controller.

In one embodiment, the robotic work tool further comprises a position sensor. The position sensor is configured to detect a position of the robotic work tool when the robotic work tool is caused to travel in accordance with the received trajectory data representing the desired travel route. A detected position is communicated to the at least one controller.

In one embodiment, the robotic work tool system further comprises at least one output device configured to output information related said travel data.

In one embodiment, the robotic work tool is a robotic lawn mower.

According to a second aspect, there is provided a method implemented by the robotic work tool system according to the first aspect.

In one exemplary implementation, the method is performed by a robotic work tool system. The robotic work tool system comprises at least one input device configured to receive trajectory data representing a desired travel route of a robotic work tool. The trajectory data includes at least one of a distance value, a direction value and a velocity value. The robotic work tool system further comprises a robotic work tool comprising at least one motor. The at least one motor being configured to drive at least one wheel of the robotic work tool. The robotic work tool system further comprises at least one controller for controlling operation of the robotic work tool. The method comprises receiving, from the at least one input device, the trajectory data representing the desired travel route of the robotic work tool, and determining, based on the trajectory data, a control sequence for the at least one motor. The control sequence is a sequence of different power and/or velocities which the at least one wheel is to be driven with. The method further comprises controlling the at least one motor according to the determined control sequence causing the robotic work tool to be operative to travel in accordance with the received trajectory data representing the desired travel route. Thereafter, the method comprises receiving travel data relating to the driven travel route while the robotic work tool is caused to travel in accordance with the received trajectory data representing the desired travel route; and processing said travel data relating to the driven travel route.

Some of the above embodiments eliminate or at least reduce the problems discussed above. By receiving trajectory data that is used to determine a control sequence, it may be possible to control a robotic work tool to travel in accordance with a desired travel route while simultaneously receiving travel data related to the driven travel route. Thus, a robotic work tool system and method are provided that improve the way of controlling, and interacting with, the robotic work tool.

### BRIEF DESCRIPTION OF DRAWINGS

These and other aspects, features and advantages will be apparent and elucidated from the following description of various embodiments, reference being made to the accompanying drawings, in which:

FIG. 1 shows a schematic overview of a robotic work tool;

FIG. 2 shows a schematic view of a robotic work tool system;

FIG. 3 illustrates an example embodiment implementing the robotic work tool system;

FIG. 4 shows a flowchart of an example method performed by a robotic work tool system; and

FIG. 5 shows a schematic view of a computer-readable medium.

### DETAILED DESCRIPTION

The disclosed embodiments will now be described more fully hereinafter with reference to the accompanying drawings, in which certain embodiments of the robotic work tool system are shown. This robotic work tool system may, however, be embodied in many different forms and should not be construed as limited to the embodiments set forth herein; rather, these embodiments are provided by way of example so that this disclosure will be thorough and complete, and will fully convey the scope of the robotic work tool system to those skilled in the art. Like numbers refer to like elements throughout.

In one of its aspects, the disclosure presented herein concerns a robotic work tool system for controlling a robotic work tool.

The robotic work tool system comprises a robotic work tool. The robotic work tool may be realised in many different ways. While the present disclosure will mainly be described in general terms of an autonomous robot designed for mowing a lawn, it should be understood that the robotic work tool described herein may be implemented into any type of autonomous machine that may perform a desired activity along a desired travel route, including without limitation a cleaning robotic work tool, a polishing work tool, repair work tool and/or demolition work tool or the like.

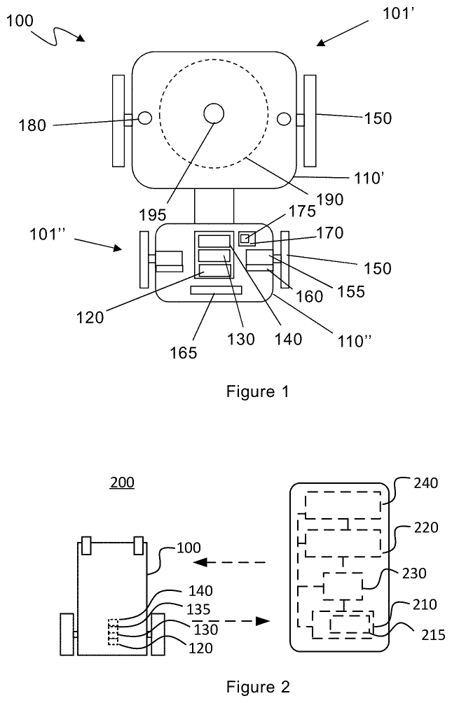

FIG. 1 shows a schematic overview of the robotic working tool 100, which is exemplified by a robotic lawnmower 100, having a front carriage 101′ and a rear carriage 101″. The robotic lawnmower 100 comprises a chassis 110, which in the embodiment shown in FIG. 1 comprises a front chassis 110′ of the front carriage 101′ and a rear chassis 110″ of the rear carriage 101″. The robotic work tool 100 further comprises a body. The body is not illustrated in FIG. 1. The body, which may be made of plastic or metal, forms a protective outer cover or housing of the robotic work tool 100 and protects components, such as motors and controller(s), which are located within the body or on the chassis 110. It is appreciated that the present disclosure is not limited to a robotic work tool 100 having separate front and rear carriages 101′, 101″. Rather, the robotic work tool 100 may also be of a type that comprises one single integral chassis and one single integral body. Therefore, in the following description, when it is not necessary to differentiate between a front and rear carriage, reference will only be made to “chassis 110” or body.

The robotic working tool 100 comprises a plurality of wheels 150. In the exemplary embodiment of FIG. 1, the robotic working tool 100 comprises two pair of wheels 150. One pair of front wheels 150 is arranged in the front carriage 101′ and one pair of rear wheels 150 is arranged in the rear carriage 101″. At least some of the wheels 150 are drivably connected to at least one electric motor 155. It is appreciated that combustion engines may alternatively be used, possibly in combination with an electric motor.

As illustrated in FIG. 1, each of the rear wheels 150 may be connected to a respective electric motor 155. This allows for driving the rear wheels 150 independently of one another, which, for example, enables steep turning. Alternatively, each of the wheels 150 may be connected to a respective electric motor 155. This allows for driving each wheel 150 independently of one another.

The robotic work tool 100 also comprises at least one controller 130. The controller 130 is implemented using instructions that enable hardware functionality, for example, by using executable computer program instructions in a general-purpose or special-purpose processor that may be stored on a computer readable storage medium (disk, memory etc.) to be executed by such a processor. The controller 130 is configured to read instructions from a memory 140 and execute these instructions to control the operation of the robotic work tool 100 including, but not being limited to, the propulsion of the robotic work tool 100. The controller 130 may be implemented using any suitable processor or Programmable Logic Circuit (PLC). The memory 140 may be implemented using any commonly known technology for computer-readable memories such as ROM, RAM, SRAM, DRAM, FLASH, DDR, SDRAM or some other memory technology.

With reference to the FIG. 2, a first embodiment according to the first aspect will now be described. FIG. 2 shows a schematic view of a robotic work tool system 200 according to one embodiment. As will be appreciated, the schematic view is not to scale.

As illustrated in FIG. 2, the robotic work tool system 200 comprises at least one input device 120, 220, a robotic work tool 100 and at least one controller 130, 230.

The at least one input device 120, 220 is configured to received trajectory data representing a desired travel route of the robotic work tool 100. The trajectory data includes at least one of a distance value, a direction value and a velocity value. Accordingly, the at least one input device 120, 220 is configured to receive data that describes a desired travel route in terms of at least one of a distance, a direction and a velocity. The at least one input device 120 may be located in the robotic work tool 100, or the at least one input device 220 may be located in a device that is separate from the robotic work tool 100. When the at least one input device 220 is located in another device than in the robotic work tool 100, the separate device is communicatively coupled to the robotic work tool 100 by a wireless communication interface 135 arranged with the robotic work tool 100. The robotic work tool 100 may additionally, or alternatively, use the wireless communication interface 135 to communicate with other devices, such as servers, personal computers or smartphones, charging stations, remote controls, other robotic work tools or any remote device which comprises a wireless communication interface and a controller. Examples of such wireless communication are Bluetooth®, Global System Mobile (GSM) and LTE (Long Term Evolution), 5G New Radio, to name a few.

The robotic work tool system 200 further comprises at least one controller 130, 230 for controlling operation of the robotic work tool 100. In one embodiment, the at least one controller 130, 230 may be embodied as a hardware controller. The at least one controller 130, 230 may be implemented using any suitable, publicly available processor or Programmable Logic Circuit (PLC). For example, the at least one controller 130, 230 may be the controller 130 located in the robotic work tool 100. According to another example, the at least one controller 230 may be located in a device that is separate from the robotic work tool 100. When the at least one controller 230 is located in another device than in the robotic work tool 100, the separate device is communicatively coupled to the robotic work tool 100. In another embodiment, the at least one controller 230 is embodied as software, e.g. remotely in a cloud-based solution.

The at least one controller 130, 230 is configured to receive the trajectory data representing the desired travel route of the robotic work tool 100 from the at least one input device 120, 220. The at least one controller 130, 230 is thereafter configured to determine, based on the trajectory data, a control sequence for the at least one motor 155. The control sequence is a sequence of different power and/or velocities which the at least one wheel 150 is to be driven with. In one embodiment, the control sequence is a sequence of different velocities which the at least one wheel 150 is to be driven with. According to another embodiment, the control sequence is a sequence of different power for the at least one motor 155 to drive the at least one wheel 150 with. According to still another embodiment, the control sequence is a sequence of different velocities and power which the at least one wheel 150 is to be driven with.

In embodiments when the robotic work tool 100 comprises a plurality of motors 155, the determined control sequence may be the same control sequence for all of the plurality of motors 155. Alternatively, the control sequence may differ between the plurality of motors 155. Different control sequences for the plurality of motors 155 may make it possible to perform turns, as the wheels 150 of the robotic work tool 100 may be driven by different velocities and/or power.

Accordingly, the at least one controller 130, 230 is configured to determine how the robotic work tool 100 should be driven based on the received trajectory data. The at least one controller 130, 230 may, for example, determine by which power the robotic work tool 100 should be driven, by which velocity, the distance that robotic work tool 100 should be driven, and how quickly the power driving the robotic work tool 100 should decrease. This information is translated into the control sequence. The at least one motor 155 is then controlled according to the determined control sequence causing the robotic work tool 100 to be operative to travel in accordance with the received trajectory data representing the desired travel route. Thus, the received trajectory data is used to control the robotic work tool 100 to travel in accordance with a desired travel route.

As an illustrative example, the control sequence may comprise a sequence of three different velocities that should be used for 2, 4 and 3 seconds respectively. Accordingly, the at least one wheel 150 should be driven with a first velocity for 2 seconds, with a second velocity for 4 seconds and with a third velocity for 3 seconds.

The at least one controller 130, 230 is further configured to receive, from the robotic work tool 100, travel data relating to the driven travel route. The travel data is received while the robotic work tool 100 is caused to travel in accordance with the received trajectory data representing the desired travel route. The at least one controller 130, 230 is configured to process the travel data relating to the driven travel route. The travel data may be any data that relates to the driven travel route. It may relate to the position of the robotic work tool 100 while driving the travel route. The travel data may additionally, or alternatively, relate to the end position of the robotic work tool 100 after it has driven the travel route. Additionally, or alternatively, the travel data may relate to collisions that has occurred while the robotic work tool 100 was travelling the travel route.

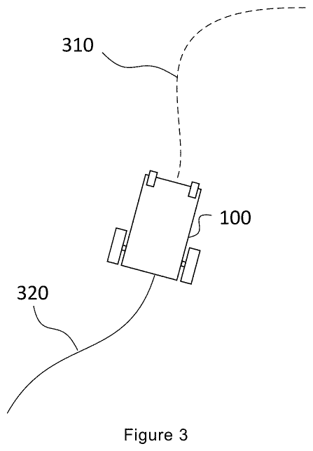

FIG. 3 illustrates an example embodiment implementing the proposed robotic work system 200. The robotic work tool system 200 has received information relating to a desired travel route. As previously described, the trajectory data representing the desired travel route includes information about at least one of a distance, a direction and a velocity. The dotted line 310 in front of the robotic work tool 100 in FIG. 3 represents the trajectory data. As seen in FIG. 3, the trajectory data includes at least information of the distance and the direction that is desired that the robotic work tool 100 should travel. The solid line 320 behind the robotic work tool 100 in FIG. 3 represents the driven travel route, i.e. the travel route that the at least one motor 155 has been controlled, by the at least one controller 130, 230, to drive the at least one wheel 150 with.

By introducing the above proposed robotic work tool system 200, the previously described disadvantages are eliminated or at least reduced. It may be possible to control the robotic work tool 100 to travel in accordance with a more detailed travel route. This may be advantageous when it is desirable that the robotic work tool 100 only mows the grass along a path, but not mows the larger area. This may be used when, for example, a large meadow is wanted. Even if major parts of the area should be left uncut, it may still be wanted to have the possibility to walk along a cut path across the meadow. Another example of the advantageous of the proposed robotic work tool system 200 may be when it is wanted to cut a certain pattern within a work area. This pattern may, for example, be of decorative purposes or may be used to indicate certain areas within the work area. Accordingly, with the proposed robotic work tool system 200, an improved way of controlling the robotic work tool 100 is provided. Furthermore, as the system 200 receives and processes travel data, i.e. information related to the travelled route, the possibilities for analysing the current travel route and/or for taking decisions relating to subsequent actions may be improved. Thus, an improved interaction with the robotic work tool 100 is provided.

In some embodiments, the robotic work tool system 200 may comprise a user interface 210 configured to receive user input from a user during the user's operation and interaction with said user interface 210. The user interface 210 may be configured to receive input related to, and associated with, the desired travel route. The user interface 210 may, for example, be a touch user interface. The user interface 210 is preferably separated from the robotic work tool 100 as illustrated in FIG. 2. However, in some embodiments, the user interface 210 may be located at the robotic work tool 100.

In one embodiment, the at least one input device 120, 220 may comprise the user interface 210, i.e. the at least one input device 120, 220 may be the user interface 210. The user interface 210 may be configured to receive trajectory data representing the desired travel route of the robotic work tool 100. A user may, according to the embodiment, interact with the user interface 210 in order for the robotic work tool 200 to receive trajectory data representing a desired travel route of the robotic work tool 100. For example, a user may draw a desired travel route of the robotic work tool 100 using the user interface 210. This data is thereafter received by the at least one controller 130, 230 and used for determining the control sequence.

By providing a user interface 210 that may receive trajectory data, a more accurate travel route may be obtained wherein better control of the robotic work tool 100 may be achieved. For example, in some embodiments, the user may input and illustrate the desired travel route of the robotic work tool 100 using the user interface 210. The user may thereafter adapt the travel route before the trajectory data is received by the at least one controller 130, 230. Thus, a flexible way of providing a more accurate travel route of the robotic work tool 100 may be achieved.

In some embodiments, the at least one input device 120, 220 may comprise a recording device. The recording device may be configured to record a travel route of the robotic work tool 100 while the robotic work tool 100 is moved along a travel route representing the desired travel route of the robotic work tool 100. The recording device may register a distance and/or a force with which the robotic work tool 100 is moved along a travel route.

The recording device may, for example, be configured to record the travel route of the robotic work tool 100 while the robotic work tool 100 is pulled backwards along a travel route representing the desired travel route of the robotic work tool 100. Alternatively, the recording device may be configured to record the travel route of the robotic work tool 100 while the robotic work tool 100 is pulled, or pushed, forwards along a travel route representing the desired travel route of the robotic work tool 100. In still one embodiment, the recording device may be configured to record the travel route of the robotic work tool 100 while the robotic work tool 100 is pulled, or pushed, both backwards and forwards along a travel route representing the desired travel route of the robotic work tool 100. When the movement of the robotic work tool 100 stops, the at least one motor 155 is controlled according to the determined control sequence based on the received trajectory data and the robotic work tool 100 is caused to be operative to travel in accordance with the desired travel route. The robotic work tool 100 may, in some embodiments, be configured to move forward in accordance with the desired travel route as soon as the recording device stops receiving trajectory data, i.e. when the movement of the robotic work tool 100 along the recorded desired travel route stops.

In some of the embodiments, when the robotic work tool 100 is moved a distance to record the travel route representing the desired travel route, the robotic work tool 100 may further be configured to apply a counter-force while the robotic work tool 100 is moved. The counter-force grows larger the further the robotic work tool 100 is moved. As the counter-force grows larger, the heavier it gets to move the robotic work tool 100. The applied counter-force may be measured by the at least one input device 120, 220 and used by the at least one controller 130, 230 when determining the control sequence. The amount of applied counter-force will, for example, be reflected in the subsequent velocity and/or the distance that the robotic work tool 100 will travel. For example, a great counter-force may cause a high velocity and/or a long distance.

In one embodiment, the recording device may be configured to record the travel route of the robotic work tool 100 while the at least one wheel 150 of the robotic work tool 100 is spun a distance representing the desired travel route of the robotic work tool 100. According to the embodiment, a user may lift up the robotic work tool 100 from the ground and spin the at least one wheel 150, wherein the recording device is configured to receive trajectory data representing the desired travel route of the robotic work tool 100 by recording the distance that the at least one wheel 150 is spun in the air. The robotic work tool 100 may according to this embodiment be configured to move forward in accordance with the desired travel route as soon as the robotic work tool 100 is put down to the ground again.

The recording device may use odometry to estimate the change in position over time. The recording device may, for example, be an encoder 160. The encoder 160 may be configured to record the travel route of the robotic work tool 100 by tracking rotation of the at least one wheel 150. Thus, the at least one controller 130, 230 may receive the trajectory data from the encoder 160, wherein the trajectory data comprises the rotation of the at least one wheel 150 tracked by the encoder 160. Based on the received trajectory data representing the desired travel route, i.e. the data comprising the rotation of the at least one wheel 150, the at least one controller 130, 230 may determine a control sequence for the at least one motor 155. Accordingly, the at least one controller 130, 230 may receive the pulses noted by the encoder 160, which may be transformed into distances per time units. Based on this information, the at least one controller 130, 230 may determine a sequence of different power for the at least one motor 155 in order for the robotic work tool 100 to travel in accordance with the received trajectory data. By realizing the input device 120, 220 by the encoder 160, a relatively simple but accurate input device 120, 220 is provided.

In one embodiment, the at least one controller 130, 230 may further be configured to determine the control sequence for the at least one motor 155 by scaling the received trajectory data representing the desired travel route by a scaling factor. The scaling factor may be a fixed number, or may be determined based on information related to the received trajectory data. For example, in embodiments when the robotic work tool 100 is moved a distance to record the travel route representing the desired travel route, the robotic work tool 100 may be configured to measure an applied force and/or be configured to apply a counter-force. The amount of applied force may be used to determine the scaling factor. The scaling factor may, for example, be used to magnify or reduce the distance and/or the velocity of the received trajectory data. Additionally, or alternatively, the scaling factor may be used with the received trajectory data to reflect how quickly the power driving the robotic work tool 100 should decrease. By using a scaling factor, it may be possible to scale the received trajectory data. Thus, the trajectory data received by the robotic work tool system 200 does not have to exactly mirroring the desired travel route. For example, if it is desired that the robotic work tool 100 should travel a long distance over a large area and the trajectory data is received by moving the robotic work tool 100 along a desired travel route, it may be inconvenient to move the robotic work tool 100 a distance that is of an equal length as the desired travel route.

In one embodiment, the scaling factor is set automatically. In another embodiment, the at least one input device 120, 220 may be configured to receive input representing the scaling factor. By providing the possibility to input the scaling factor by the at least one input device 120, 220, the at least one input device 120, 220 may be used to choose the scaling factor which determines how the trajectory data should be converted into the control sequence. As mentioned, the scaling factor may determine which input, e.g. a received distance or force, that may result in that the robotic work tool 100 travels a certain distance.

The robotic work tool 100 may, according to some embodiments, comprise at least one sensor unit. The at least one sensor unit may be configured to collect sensed input data. The collected sensed input data may represent travel data. The at least one sensor unit may be configured to collect the sensed input data while the robotic work tool 100 is caused to be operative to travel in accordance with the received trajectory data representing the desired travel route. The collected sensed input data, or travel data, may be obtained, by the at least one sensor, by for example sensing local terrain features and the collected sensed input data may for example be, without limitations, image data, odometric data, load data, position data, collision data etc.

The at least one sensor unit may, for example, be a collision sensor 180. A robotic work tool comprising a collision sensor 180 is illustrated in FIG. 1. The collision sensor 180 may be configured to detect a collision when the robotic work tool 100 is caused to travel in accordance with the received trajectory data representing the desired travel route. Information of a detected collision may be communicated to the at least one controller 130, 230. The at least one controller 130, 230 may thus receive information about the detected collision and may process this information. The at least one controller 130, 230 may use this information to determine a subsequent action of the robotic work tool 100. Additionally, or alternatively, the at least one controller 130, 230 may be configured to communicate the collision data to another controller. The other controller may, for example, be located in the object that the robotic work tool 100 collided with. Then, this other controller may use the received collision data to determine subsequent actions of that object. In one embodiment, the data about the detected collision may be stored within at least one memory 140, 240. The data may be stored locally within the robotic work tool 100 and/or the data may be stored remote from the robotic work tool 100.

The collision sensor 180 is connected to the controller 130 of the robotic work tool 100, and the controller 130 may be configured to process and evaluate any signals received from the collision sensor 180. The collision sensor 180 is configured to detect a direction of a movement of the chassis 110 with respect to the body of the robotic work tool 100. The movement is indicative of a collision. The movement may also be indicative of a lift of the robotic work tool 100. Accordingly, the collision sensor 180 may detect a direction of a movement in any direction.

The collision sensor 180 may comprise at least one collision sensor arrangement. The collision sensor 180 may, for example, comprise at least one three-dimensional sensor arrangement for detecting relative movement of the body and the chassis 110 of the robotic work tool 100. The three-dimensional sensor arrangement may comprise a sensor element and a detection element. The sensor element may be arranged on, or in, one of the body and the chassis. The detection element may be arranged in, or on, the other of the body and the chassis. The sensor element may preferably be a three-dimensional sensor that is configured to detect a magnetic field in a plane or in a direction (e.g. an axis) which is normal to the plane. The three-dimensional sensor element may e.g. be a three-dimensional Hall-sensor.

The at least one sensor unit may, for example, be a position sensor 170. A robotic work tool 100 comprising a position sensor 170 is illustrated in FIG. 1. The position sensor 170 may be configured to detect a position of the robotic work tool 100 when the robotic work tool 100 is caused to travel in accordance with the received trajectory data representing the desired travel route. A detected position may be communicated to the at least one controller 130, 230. The at least one controller 130, 230 may thus receive information about the detected position and may process this information. The at least one controller 130, 230 may use this information to determine a subsequent action of the robotic work tool 100. Additionally, or alternatively, the at least one controller 130, 230 may be configured to store the detected position within the memory 140, 240.

The position sensor 170 may comprises a satellite signal receiver 175. The satellite signal receiver 175 may be a Global Navigation Satellite System (GNSS) satellite signal receiver, such as a Global Positioning System (GPS) satellite signal receiver. The position sensor 170 may be connected to the controller 130 for enabling the controller 130 to determine current positions for the robotic work tool 100 using the position sensor 170.

In one embodiment, the robotic work tool system 200 may further comprise at least one output device 215 configured to output information related to said travel data. This is illustrated in FIG. 2. The output device 215 in FIG. 2 is illustrated as a part of the input device 210. However, it may be appreciated that the output device 215 alternatively may be a separate device. The output device 215 may be configured to display the information related to travel data to a user who is operating the user interface 210. In one embodiment, the travel data may be displayed in the output device 215 associated with the driven travel route, and/or associated with the desired travel route. It may be appreciated that these two routes, the driven travel route and the desired travel route, may differ from each other as unexpected events that may affect the robotic work tool 100 can occur while the robotic work tool 100 is driving the travel route. The travel data may be received by the at least one sensor unit, and may be any data related to the driven route. The travel data may, for example, include photo data, odometric data, load data, position data, collision data etc.

In one advantageous embodiment, the robotic work tool 100 may be a robotic lawn mower. The robotic work tool 100 may in such embodiment comprise a work tool, which may include a grass cutting device 190 as illustrated in FIG. 1. The grass cutting device 190 may comprise a rotating blade driven by a cutter motor 195. The cutter motor 195 may be connected to the controller 130, which enables the controller 130 to control the operation of the cutter motor 195. The robotic work tool 100 also has (at least) one battery 165 for providing power to the motors 155 and the cutter motor 195.

Even if the above proposed robotic work tool system 200 is mainly described with regard to the main tasks of a robotic work tool 100, e.g. mowing a lawn, it should be appreciated that the robotic work tool system 200 may also be used for other purposes. For example, the proposed robotic work tool system 200 may be used in a garden game. In its simplest form, the proposed robotic work tool system 200 may be used for garden bowling. In such embodiment, the user may input the desired travel route into the robotic work tool system 200. This may be performed in accordance with any of the previously described ways of inputting trajectory data, for example by using a user interface 210 or by moving the robotic work tool 100 in accordance with a desired travel route. The trajectory data may represent a travel route that the user wants the robotic work tool 100 to travel in order to knock down a number of tenpins. The at least one controller 130, 230 may thereafter, by determining a control sequence, cause the robotic work tool 100 to travel in accordance with the received trajectory data. As the robotic work tool 100 travels the desired travel route, the at least one controller 230 may receive information relating to the driven travel route, and that travel data may be processed. It may thus be possible for the robotic work tool 200 to keep track of the turn order, and/or to assist with counting points by counting the number of hit tenpins. The result may, for example, be output using the output device 215.

In another embodiment, the garden game may be a game where a user should replicate a pattern. For example, the user is instructed to replicate a pattern representing a circle. The user thereafter inputs the pattern to the robotic work tool system 200 by, for example, moving the robotic work tool 100 along a travel route representing the desired travel route, i.e. the pattern, or by using a user interface 210. The robotic work tool 200 thereafter determine the control sequence and control the at least one motor 155 to cause the robotic work tool 100 to travel in accordance with the received pattern. The robotic work tool system 200 may receive travel data representing the position of the robotic work tool 100 while driving in accordance with the input trajectory data. The at least one controller 130, 230 may thereafter be configured to process the position data and to calculate the driven travel route. The driven travel route may be compared against the pattern that the user was instructed to replicate, and the user may get points depending on the resemblance between the two patterns and in accordance with how well the two pattern match. The result may, for example, be presented to the user using the output device 215.

In another embodiment, the proposed robotic work tool system 200 may be used to play a variant of curling. The robotic work tool system 200 in such embodiments may comprise a plurality robotic work tools 100. Each robotic work tool 100 may be used as a curling stone. The robotic work tool 100 may be set off with a speed and a direction in accordance with the received trajectory data towards a point zone. The point zone may be visually indicated in the play area. Additionally, the boundaries of the point zone may be set using existing techniques for setting boundaries for work areas. If the robotic work tools 100 comprise position sensors 170, the robotic work tool system 200 may determine where the respective robotic work tool 100 is located and what amount of points that each robotic work tool 100 should be awarded. The robotic work tools 100 may further comprise collision sensors 180, and when one of the robotic work tools 100 hits another robotic work tool 100, i.e. a curling stone hits another curling stone, the collision may be detected by the robotic work tool 100 and reported to the at least one controller 130, 230. Additionally, the detected collision may further be communicated to the hit robotic work tool 100. The hit robotic work tool 100 may then be configured to move away from the colliding position with a distance that corresponds with the received data related to the collision. The data related to the collision may be both the force with which the robotic work tool 100 was hit and the direction of the collision.

In still another embodiment, the robotic work tool system 200 may be used in a garden game similar to golf. In this embodiment, the aim may be to get the robotic work tool 100 to a certain position representing the golf hole. The trajectory data received by the input device 120, 220 represents the desired travel route of the golf ball, where the robotic work tool 100 first represents the golf club and thereafter the golf ball. The final destination of the robotic work tool 100 represents where the golf ball ended up after the golf club hit the golf ball.

Before the trajectory data is received by the input device 120, 220, a scaling factor representing the type of golf club may be selected. Depending on which golf club that is selected, the received trajectory data should be scaled differently. For example, for a driver the velocity of the robotic work tool 100 should slowly decrease and the sensitivity for curved balls should be high. While for an iron 8, the velocity for the robotic work tool 100 should decrease fast and the sensitivity for curved balls should be medium. For a putter, the velocity of the robotic work tool 100 should slowly decrease, the speed of the robotic work tool 100 should be low and there should be no curved balls, i.e. only dependent of green shape.

The trajectory data may be received by the at least one input device 120, 220 by pulling the robotic work tool 100 backwards. The movement of the robotic work tool 100 backwards represents the swing of the golf club. The force may increase the further the robotic work tool 100 is pulled backwards. If the robotic work tool 100 is pulled with a twist, this will represent a slice or a hook. When the robotic work tool 100 is released, the robotic work tool 100 may take off and be caused to travel in accordance with the received trajectory data. The higher power that has built up during the movement along the desired travel route, the longer the robotic work tool 100 may travel. The robotic work tool 100 will be caused to travel and slowdown in accordance with the received trajectory data and the scaling factor, i.e. the club choice.

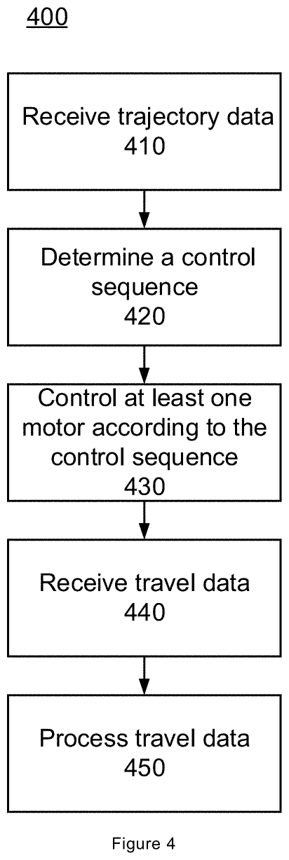

According to a second aspect, there is provided a method 400 performed by the robotic work tool system 100 according to the first aspect. The method will be described with reference to FIG. 4.

In one embodiment, the robotic work tool system 200 comprises at least one input device 120, 220. The at least one input device 120, 220 is configured to receive trajectory data representing a desired travel route of a robotic work tool 100. The trajectory data includes at least one of a distance value, a direction value and a velocity value. The robotic work tool system 200 further comprises a robotic work tool 100. The robotic work tool 100 comprises at least one motor 155. The at least one motor 155 is configured to drive at least one wheel 150 of the robotic work tool 100. The robotic work tool system 200 further comprises at least one controller 130, 230 for controlling operation of the robotic work tool 100. The method comprises step 410 of receiving, from the at least one input device 120, 220, the trajectory data representing the desired travel route of the robotic work tool 100. The method further comprises step 420 of determining, based on the trajectory data, a control sequence for the at least one motor 155. The control sequence is a sequence of different velocities which the at least one wheel 150 is to be driven with. Thereafter, step 430 of controlling the at least one motor 155 according to the determined control sequence may be performed. This causes the robotic work tool 100 to be operative to travel in accordance with the received trajectory data representing the desired travel route. The method then comprises step 440 of receiving travel data relating to the driven travel route while the robotic work tool 100 is caused to travel in accordance with the received trajectory data representing the desired travel route and step 450 of processing said travel data relating to the driven travel route.

By introducing the above proposed method, it may be possible to control not only in which area a robotic work tool 100 should operate within, but also to control the robotic work tool 100 to travel in accordance with a more detailed travel route. The proposed method 400 may provide an improved way of controlling the robotic work tool 100. Furthermore, as the method comprises the steps 440 and 450 of receiving and processing travel data, i.e. information related to the travelled route, the possibilities for analysing the current travel route and/or for taking decisions relating to subsequent actions may be improved. Thus, improved interaction with the robotic work tool 100 is provided.

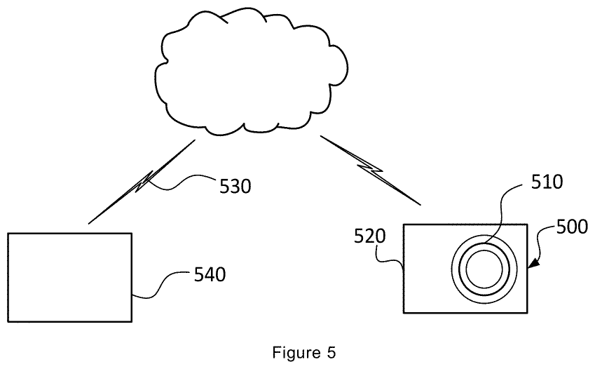

FIG. 5 shows a schematic view of a computer-readable medium as described in the above. The computer-readable medium 500 is in this embodiment a data disc 500. In one embodiment the data disc 500 is a magnetic data storage disc. The data disc 500 is configured to carry instructions 510 that when loaded into a controller, such as a processor, execute a method or procedure according to the embodiments disclosed above. The data disc 500 is arranged to be connected to and read by a reading device 520, for loading the instructions into the controller. One such example of a reading device 520 in combination with one (or several) data disc(s) 500 is a hard drive. It should be noted that the computer-readable medium can also be other mediums such as compact discs, digital video discs, flash memories or other memory technologies commonly used. In such an embodiment the data disc 500 is one type of a tangible computer-readable medium 500.

The instructions 510 may also be downloaded to a computer data reading device 540, such as the controller 130, 230 or other device capable of reading computer coded data on a computer-readable medium, by comprising the instructions 510 in a computer-readable signal 530 which is transmitted via a wireless (or wired) interface (for example via the Internet) to the computer data reading device 540 for loading the instructions 510 into a controller. In such an embodiment the computer-readable signal 530 is one type of a non-tangible computer-readable medium 500.

The instructions may be stored in a memory (not shown explicitly in FIG. 5, but referenced 140, 240 in FIG. 2) of the computer data reading device 540.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc. Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Still further, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A robotic work tool system, comprising:
at least one input device configured to receive trajectory data representing a desired travel route of a robotic work tool, the trajectory data including at least one of a distance value, a direction value and a velocity value;
a robotic work tool comprising at least one motor, the at least one motor being configured to drive at least one wheel of the robotic work tool; and
at least one controller for controlling operation of the robotic work tool, the at least one controller being configured to:
receive said trajectory data representing the desired travel route of the robotic work tool from the at least one input device;
determine, based on the trajectory data, a control sequence for the at least one motor, said control sequence being a sequence of different power and velocities which the at least one wheel is to be driven with;
control the at least one motor according to the determined control sequence causing the robotic work tool to be operative to travel in accordance with the received trajectory data representing the desired travel route;
receive, from the robotic work tool, travel data relating to the driven travel route, wherein said travel data is received while the robotic work tool is caused to travel in accordance with the received trajectory data representing the desired travel route; and
process said travel data relating to the driven travel route.

2. The robotic work tool system according to claim 1, wherein the robotic work tool system comprises a user interface configured to receive user input from a user during the user's operation and interaction with said user interface, wherein the user interface is configured to receive input related to the desired travel route.

3. The robotic work tool system according to claim 2, wherein the at least one input device comprises the user interfaced, wherein the user interface is configured to receive trajectory data representing the desired travel route of the robotic work tool.

4. The robotic work tool system according to claim 1, wherein the at least one input device comprises a recording device, wherein the recording device is configured to record a travel route of the robotic work tool while the robotic work tool is moved along a travel route representing the desired travel route of the robotic work tool.

5. The robotic work tool system according to claim 4, wherein the recording device is configured to record the travel route of the robotic work tool while the robotic work tool is pulled backwards or forwards along a travel route representing the desired travel route of the robotic work tool.

6. The robotic work tool system according to claim 4, wherein the recording device is configured to record the travel route of the robotic work tool while the at least one wheel of the robotic work tool is spun a distance representing the desired travel route of the robotic work tool.

7. The robotic work tool system according to claim 4, wherein the recording device is an encoder and wherein the encoder is configured to record the travel route of the robotic work tool by tracking rotation of the at least one wheel.

8. The robotic work tool system according to claim 1, wherein the at least one controller further configured to determine the control sequence for the at least one motor by scaling the received trajectory data representing the desired travel route by a scaling factor.

9. The robotic work tool system according to claim 8, wherein the at least one input device is further configured to receive input representing the scaling factor.

10. The robotic work tool system according to claim 1, wherein the robotic work tool further comprises a collision sensor configured to detect a collision when the robotic work tool is caused to travel in accordance with the received trajectory data representing the desired travel route and wherein information of a detected collision is communicated to the at least one controller.

11. The robotic work tool system according to claim 1, wherein the robotic work tool further comprises a position sensor and wherein said position sensor is configured to detect a position of the robotic work tool when the robotic work tool is caused to travel in accordance with the received trajectory data representing the desired travel route and wherein a detected position is communicated to the at least one controller.

12. The robotic work tool system according to claim 1, wherein the robotic work tool system further comprises at least one output device configured to output information related to said travel data.

13. The robotic work tool system according to claim 1, wherein the robotic work tool is a robotic lawnmower.

14. A method performed by a robotic work tool system, wherein the robotic work tool system comprises:
at least one input device configured to receive trajectory data representing a desired travel route of a robotic work tool, the trajectory data including at least one of a distance value, a direction value and a velocity value;
a robotic work tool comprising at least one motor, the at least one motor being configured to drive at least one wheel of the robotic work tool; and
at least one controller for controlling operation of the robotic work tool, the method comprising:
receiving, from the at least one input device, said trajectory data representing the desired travel route of the robotic work tool;
determining, based on the trajectory data, a control sequence for the at least one motor, said control sequence being a sequence of different velocities which the at least one wheel is to be driven with;
controlling the at least one motor according to the determined control sequence causing the robotic work tool to be operative to travel in accordance with the received trajectory data representing the desired travel route;
receiving travel data relating to the driven travel route while the robotic work tool is caused to travel in accordance with the received trajectory data representing the desired travel route; and
processing said travel data relating to the driven travel route.
